(19) United States
(12) Patent Application Publication
(10) Pub. No.: US 2024/0178582 A1
(43) Pub. Date: May 30, 2024

(54) MANUFACTURING METHOD FOR TERMINAL-EQUIPPED ELECTRIC WIRE, AND TERMINAL-EQUIPPED ELECTRIC WIRE

(71) Applicant: YAZAKI CORPORATION, Tokyo (JP)

(72) Inventor: Naoki Ito, Makinohara-shi (JP)

(21) Appl. No.: 18/496,790

(22) Filed: Oct. 27, 2023

(30) Foreign Application Priority Data
Nov. 30, 2022 (JP) 2022-191052

(51) Int. Cl. H01R 4/18; H01R 43/048

(52) U.S. Cl. CPC H01R 4/183; H01R 43/048

(57) ABSTRACT

In a manufacturing method for a terminal-equipped electric wire, at an annular covering piece forming step, a part of a covering part on a core wire exposed part side is cut into an annular shape, thereby forming an annular covering piece. At a moving step, the annular covering piece is moved from the covering part side of the core wire exposed part to a tip side of the core wire exposed part. At an inserting step, against an opening part of a core wire accommodating part of a terminal including the core wire accommodating part that accommodates the core wire exposed part and connected to the electric wire, the annular covering piece moved to the tip side of the core wire exposed part at the moving step is butted.

### CROSS-REFERENCE TO RELATED APPLICATION(S)

The present application claims priority to and incorporates by reference the entire contents of Japanese Patent Application No. 2022-191052 filed in Japan on Nov. 30, 2022.

### BACKGROUND OF THE INVENTION

### 1. Field of the Invention

The present invention relates to a manufacturing method for a terminal-equipped electric wire, and a terminal-equipped electric wire.

### 2. Description of the Related Art

As a conventional manufacturing method for a terminal-equipped electric wire, for example, Japanese Patent Application Laid-open No. 2014-164915 describes an electric wire insertion method in which a core wire exposed part of a covered electric wire is inserted into a sealed tube terminal that includes an opening part where the electric wire can be inserted. In this electric wire insertion method, while a part of a covering material is left in a semi-stripped state and the semi-stripped covering material is in contact with a covering transfer jig provided at the opening part of the sealed tube terminal, the core wire exposed part is inserted into the sealed tube terminal.

Incidentally, in the above-mentioned electric wire insertion method according to Japanese Patent Application Laid-open No. 2014-164915, the inner diameter of the opening part of the sealed tube terminal is larger than the outer diameter of the covering material, and therefore, the covering material is also inserted into the sealed tube terminal together with the core wire exposed part. Accordingly, the electric wire insertion method requires the insertion of the core wire exposed part into the sealed tube terminal with the semi-stripped covering material received by the covering transfer jig, and in this point, there is room for further improvement.

### SUMMARY OF THE INVENTION

The present invention has been made in view of the above, and it is an object of the present invention to provide a manufacturing method for a terminal-equipped electric wire that can properly manufacture a terminal-equipped electric wire, and a terminal-equipped electric wire manufactured by this manufacturing method.

To achieve the object of the present invention, a manufacturing method for a terminal-equipped electric wire according to one aspect of the present invention includes forming a core wire exposed part by cutting and removing an end part of a covering part of an electric wire including a core wire with conductivity and the covering part that covers the core wire, thereby forming a core wire exposed part where a part of the core wire is exposed; forming an annular covering piece, after the forming the core wire exposed part, by cutting a part of the covering part on a side of the core wire exposed part into an annular shape, thereby forming an annular covering piece; moving the annular covering piece from a side of the covering part of the core wire exposed part to a side of a tip of the core wire exposed part; inserting the core wire exposed part into a core wire accommodating part while sliding the annular covering piece on the core wire exposed part, with the annular covering piece moved to the side of the tip of the core wire exposed part at the moving the annular covering piece butted against an opening part of the core wire accommodating part of a terminal including the core wire accommodating part that accommodates the core wire exposed part and connected to the electric wire; and crimping the core wire exposed part with the core wire exposed part inserted in the core wire accommodating part.

A terminal-equipped electric wire according to another aspect of the present invention includes an electric wire including a core wire with conductivity and a covering part that covers the core wire; and a terminal including an electric connection part to be connected to a counterpart connection member, and a core wire accommodating part with a hollow tubular shape formed integrally with the electric connection part, wherein the electric wire includes a core wire exposed part exposed from an end part of the covering part and crimped in a state of being accommodated in the core wire accommodating part, and an annular covering piece provided between the core wire accommodating part and the covering part and formed in an annular shape.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded side view illustrating a structure example of a terminal-equipped electric wire according to an embodiment;

FIG. 2 is a side view illustrating a manufacturing process (No. 1) of the terminal-equipped electric wire according to the embodiment;

FIG. 3 is a side view illustrating the manufacturing process (No. 2) of the terminal-equipped electric wire according to the embodiment;

FIG. 4 is a flowchart expressing the manufacturing process of the terminal-equipped electric wire according to the embodiment;

FIG. 5 is a side view illustrating a position of an annular covering piece according to a modification of the embodiment;

FIG. 6 is a side view illustrating a structure example of a terminal according to a reference example;

FIG. 7 is a side view illustrating a manufacturing process of a terminal-equipped electric wire according to the reference example;

FIG. 8 is a flowchart expressing a manufacturing process of the terminal-equipped electric wire according to the reference example;

FIG. 9 is a side view illustrating a structure example of a terminal according to a first modification of the reference example; and

FIG. 10 is a side view illustrating a structure example of a terminal according to a second modification of the reference example.

### DETAILED DESCRIPTION OF THE PREFERRED EMBODIMENTS

A mode (embodiment) for carrying out the present invention will be described in detail with reference to the drawings. The present invention is not limited by the contents described in the following embodiment. The components described below include those that can be readily conceived by persons who are skilled in the art and those that are substantially the same. Furthermore, the structures to be described below can be combined as appropriate. In addition, various omissions, substitutions or changes in the structure can be made without departing from the gist of the present invention.

### Embodiment

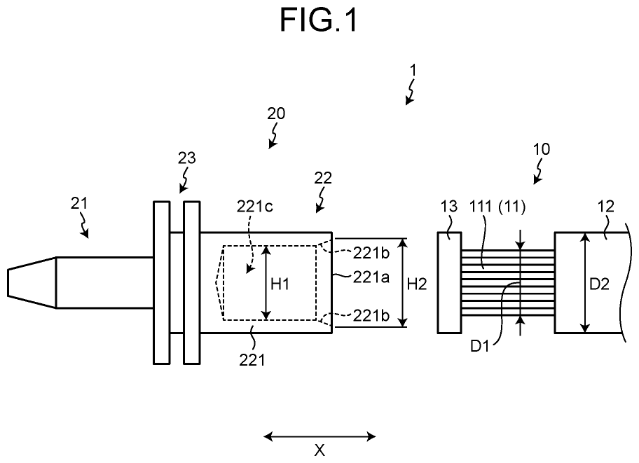

With reference to the drawings, a terminal-equipped electric wire 1 according to an embodiment will be described. The terminal-equipped electric wire 1 is electrically connected to a counterpart terminal (not illustrated), and as illustrated in FIG. 1, includes an electric wire 10 and a terminal 20. In the following description, a longitudinal direction of the terminal 20 is referred to as an axial direction X. The electric wire 10 includes a core wire 11, a covering part 12, and an annular covering piece 13.

The core wire 11 includes a bundle of a plurality of conductive metal strands formed by a metal material such as copper. The core wire 11 includes a core wire exposed part 111 that is exposed from an end part of the covering part 12. The core wire exposed part 111 is formed by cutting and removing an end part of the covering part 12 in the axial direction X so as to expose a part of the core wire 11. In other words, the core wire exposed part 111 is a portion exposed because the end part of the covering part 12 is peeled. The core wire exposed part 111 is crimped in a state of being accommodated in a core wire accommodating part 22 of the terminal 20, which will be described below.

The covering part 12 has an insulating property and covers the core wire 11. The covering part 12 is formed of, for example, an insulating resin material (PP, PVC, cross-linked PE, etc. The material is selected suitably in consideration of abrasion resistance, chemical resistance, heat resistance, or the like). The covering part 12 covers a part of the core wire 11 that excludes the core wire exposed part 111.

The annular covering piece 13 is a portion formed by cutting a part of the covering part 12 on the core wire exposed part 111 side into an annular shape. The annular covering piece 13 is formed in the annular shape along a circumferential direction, which is, for example, the circumferential direction around an axial line along the axial direction X. In other words, the annular covering piece 13 constitutes a perfect ring with no cutouts. The annular covering piece 13 exists between the core wire accommodating part 22 of the terminal 20 and the covering part 12 and is slidably provided on the core wire exposed part 111. As described below, the annular covering piece 13 is moved to a tip side of the core wire exposed part 111 when manufacturing the terminal-equipped electric wire 1; thus, scattering of the metal strands at a tip of the core wire exposed part 111 can be suppressed, making it easier to insert the core wire exposed part 111 into the terminal 20.

The terminal 20 is a terminal formed by a metal member such as copper, a copper alloy, aluminum, or an aluminum alloy and is, for example, a closed barrel crimp terminal. The terminal 20 is a male terminal and is electrically connected to a female terminal (not illustrated) as a counterpart connection member. The terminal 20 includes an electric connection part 21, the core wire accommodating part 22, and a coupling part 23.

The electric connection part 21 is a portion that is formed by extending along the axial direction X and inserted into the female terminal. The electric connection part 21 is electrically connected to the female terminal while being inserted into the female terminal.

The core wire accommodating part 22 is a portion that accommodates the core wire exposed part 111 of the electric wire 10. The core wire accommodating part 22 is a hollow tubular portion formed integrally with the electric connection part 21, and is provided on the opposite side of the electric connection part 21 along the axial direction X via the coupling part 23. The core wire accommodating part 22 includes a tubular body 221 formed in a cylindrical shape.

In a state before the core wire exposed part 111 is crimped to the tubular body 221, an inner diameter H1 of the tubular body 221 is larger than an outer diameter D1 of an outer peripheral surface of the core wire exposed part 111. Thus, the tubular body 221 can accommodate the core wire exposed part 111 inserted thereinto. The tubular body 221 includes an interior space part 221c and an opening part 221a.

The interior space part 221c is a space provided inside the tubular body 221 to accommodate the core wire exposed part 111.

The opening part 221a is a portion provided at an end part of the tubular body 221 on the opposite side of the coupling part 23, and opened so that the core wire exposed part 111 can be inserted. The opening part 221a is circularly opened, and as illustrated in FIG. 1, an inner diameter H2 of the opening part 221a is smaller than an outer diameter D2 of the annular covering piece 13. Thus, when the core wire exposed part 111 is inserted into the tubular body 221, the opening part 221a can prevent the annular covering piece 13 from entering the interior space part 221c of the tubular body 221. The opening part 221a includes a guide surface 221b.

The guide surface 221b guides the tip of the core wire exposed part 111 into the tubular body 221 when the core wire exposed part 111 is inserted into the tubular body 221. The guide surface 221b is an inclined surface that is provided at an edge part of the opening part 221a and formed at an angle to the axial direction X. The guide surface 221b is formed so that the diameter gradually expands from the inside to the outside of the tubular body 221. The guide surface 221b guides the tip of the core wire exposed part 111 so that the tip gathers to the inside of the tubular body 221.

The coupling part 23 is a portion that couples the electric connection part 21 and the core wire accommodating part 22. The coupling part 23 exists between the electric connection part 21 and the core wire accommodating part 22 in the axial direction X.

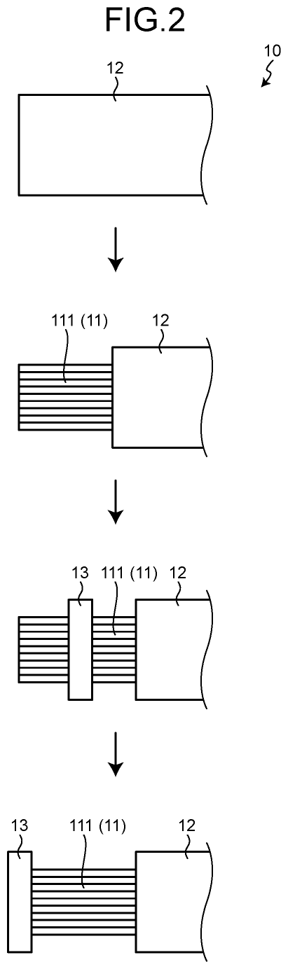

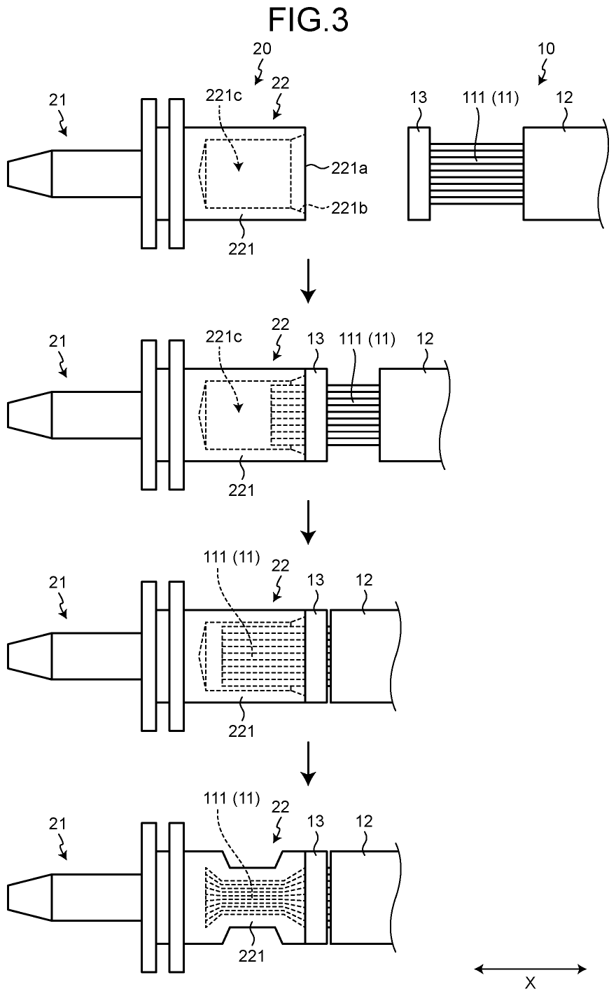

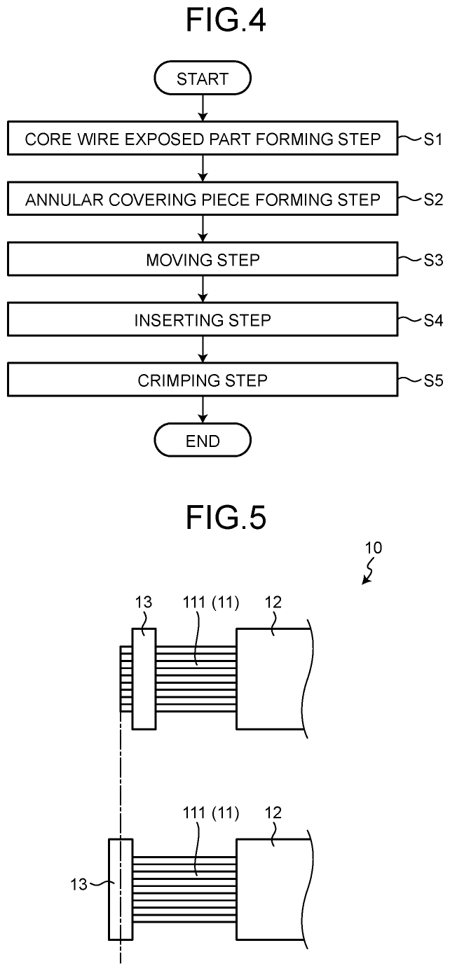

Next, with reference to FIG. 2 to FIG. 4, a manufacturing method for manufacturing the terminal-equipped electric wire 1 will be described. An operator performs a core wire exposed part forming step S1, in which the core wire exposed part 111 is formed. At the core wire exposed part forming step S1, the operator prepares the electric wire 10 in which the core wire 11 is entirely covered with the covering part 12 as illustrated in FIG. 2, for example. The operator then cuts and removes an end part of the covering part 12 of the electric wire 10 so as to form the core wire exposed part 111 where a part of the core wire 11 is exposed. After the core wire exposed part forming step S1, the operator performs an annular covering piece forming step S2, in which the annular covering piece 13 is formed. At the annular covering piece forming step S2, the operator, for example, cuts a part of the covering part 12 on the core wire exposed part 111 side into an annular shape so as to form the annular covering piece 13. Specifically, the operator forms the annular covering piece 13 to suppress the scattering of the metal strands at the tip of the core wire exposed part 111 and to facilitate the insertion of the core wire exposed part 111 into the core wire accommodating part 22 of the terminal 20. After the annular covering piece forming step S2, the operator performs a moving step S3, in which the annular covering piece 13 is moved. At the moving step S3, for example, the operator moves the annular covering piece 13 from the covering part 12 side of the core wire exposed part 111 to the tip side of the core wire exposed part 111. The operator moves the annular covering piece 13 to a position where, for example, the annular covering piece 13 is aligned with the tip of the core wire exposed part 111. Specifically, the operator moves the annular covering piece 13 to a position where an end surface of the annular covering piece 13 on the terminal 20 side in the axial direction X (on the opposite side of the covering part 12) and the tip of the core wire exposed part 111 (end part on the opposite side of the covering part 12) are aligned, which is the position where they are flush with each other. After the moving step S3, the operator performs an inserting step S4, in which the core wire exposed part 111 is inserted into the core wire accommodating part 22. At the inserting step S4, for example as illustrated in FIG. 3, the operator has the annular covering piece 13, which has been moved to the tip side of the core wire exposed part 111 at the moving step S3, butted against the opening part 221a of the core wire accommodating part 22 of the terminal 20, and in this state, inserts the core wire exposed part 111 into the core wire accommodating part 22 while sliding the annular covering piece 13 on the core wire exposed part 111. At this time, the operator inserts the core wire exposed part 111 into the core wire accommodating part 22 while guiding the tip of the core wire exposed part 111 into the core wire accommodating part 22 by the guide surface 221b of the opening part 221a. This allows the operator to insert the core wire exposed part 111 into the opening part 221a of the core wire accommodating part 22 with the metal strands at the tip of the core wire exposed part 111 gathered together without scattering, thereby improving the workability. After the inserting step S4, the operator performs a crimping step S5 to crimp the core wire exposed part 111. At the crimping step S5, for example, while the core wire exposed part 111 is inserted into the core wire accommodating part 22, the operator caulks the core wire accommodating part 22 to deform the core wire accommodating part 22, thereby crimping the core wire exposed part 111. In this way, the operator manufactures the terminal-equipped electric wire 1, in which the electric wire 10 is connected to the terminal 20.

As described above, the manufacturing method for the terminal-equipped electric wire 1 in the embodiment includes the core wire exposed part forming step S1, the annular covering piece forming step S2, the moving step S3, the inserting step S4, and the crimping step S5. At the core wire exposed part forming step S1, the end part of the covering part 12 of the electric wire 10 including the core wire 11 with the conductivity and the covering part 12 that covers the core wire 11 is cut and removed, so that the core wire exposed part 111 in which a part of the core wire 11 is exposed is formed. At the annular covering piece forming step S2, after the core wire exposed part forming step S1, a part of the covering part 12 on the core wire exposed part 111 side is cut into the annular shape, so that the annular covering piece 13 is formed. At the moving step S3, the annular covering piece 13 is moved from the covering part 12 side of the core wire exposed part 111 to the tip side of the core wire exposed part 111. At the inserting step S4, the annular covering piece 13 moved to the tip side of the core wire exposed part 111 at the moving step S3 is butted against the opening part 221a of the core wire accommodating part 22 of the terminal 20 including the core wire accommodating part 22 that accommodates the core wire exposed part 111 and connected to the electric wire 10, and in this state, the core wire exposed part 111 is inserted into the core wire accommodating part 22 while the annular covering piece 13 is slid on the core wire exposed part 111. At the crimping step S5, the core wire exposed part 111 is crimped while the core wire exposed part 111 remains inserted into the core wire accommodating part 22.

Thus, in the manufacturing method for the terminal-equipped electric wire 1, the core wire exposed part 111 is inserted into the core wire accommodating part 22 with the annular covering piece 13 butted against the opening part 221a of the core wire accommodating part 22; therefore, the core wire exposed part 111 can be inserted into the opening part 221a of the core wire accommodating part 22 with the metal strands at the tip of the core wire exposed part 111 gathered together without scattering. Accordingly, in the manufacturing method for the terminal-equipped electric wire 1, the insertion into the opening part 221a with the metal strands at the tip of the core wire exposed part 111 scattered as in the conventional art can be suppressed. As a result, the interference of the metal strands at the tip of the core wire exposed part 111 with the opening part 221a can be suppressed and thus, the workability can be improved. In addition, the manufacturing method for the terminal-equipped electric wire 1 can insert the core wire 11 into the core wire accommodating part 22 without the use of a jig to receive the annular covering piece 13 as in the conventional art, thus enabling proper manufacturing of the terminal-equipped electric wire 1.

In the manufacturing method for the terminal-equipped electric wire 1, the opening part 221a includes the guide surface 221b that guides the core wire exposed part 111, and the inner diameter H2 of the opening part 221a is smaller than the outer diameter D2 of the annular covering piece 13. At the above inserting step S4, the core wire exposed part 111 is inserted into the core wire accommodating part 22 while the tip of the core wire exposed part 111 is guided by the guide surface 221b to the inside of the core wire accommodating part 22 with the annular covering piece 13 butted against the opening part 221a. Thus, in the manufacturing method for the terminal-equipped electric wire 1, with the annular covering piece 13 butted against the opening part 221a of the core wire accommodating part 22, the interference of the tip of the core wire exposed part 111 with the opening part 221a can be suppressed by the guide surface 221b, and the core wire exposed part 111 can be inserted into the core wire accommodating part 22 more smoothly.

The terminal-equipped electric wire 1 includes the electric wire 10 including the core wire 11 and the covering part 12, and the terminal 20 including the electric connection part 21 to be connected to the counterpart connection member and the core wire accommodating part 22 with the hollow tubular shape formed integrally with the electric connection part 21. The electric wire 10 includes the core wire exposed part 111 that is exposed from the end part of the covering part 12 and crimped in the state of being accommodated in the core wire accommodating part 22, and the annular covering piece 13 that is provided between the core wire accommodating part 22 and the covering part 12 and formed in the annular shape. By this structure, the terminal-equipped electric wire 1 can achieve the terminal-equipped electric wire in which the electric wire can be inserted into the opening part 221a of the core wire accommodating part 22 with the metal strands at the tip of the core wire exposed part 111 gathered together by the annular covering piece 13.

In the terminal-equipped electric wire 1, the core wire accommodating part 22 includes the opening part 221a whose inner diameter H2 is smaller than the outer diameter D2 of the annular covering piece 13. The opening part 221a includes the guide surface 221b that guides the tip of the core wire exposed part 111 to the inside of the core wire accommodating part 22. By this structure, the terminal-equipped electric wire 1 can achieve the terminal-equipped electric wire in which the interference of the tip of the core wire exposed part 111 with the opening part 221a can be suppressed by the guide surface 221b.

In the example described above, the operator moves the annular covering piece 13 to the position where the end surface of the annular covering piece 13 on the terminal 20 side in the axial direction X and the tip of the core wire exposed part 111 are aligned, that is, they are flush with each other; however, the present invention is not limited to this example. In another example, as illustrated in FIG. 5, the end surface of the annular covering piece 13 on the terminal 20 side in the axial direction X and the tip of the core wire exposed part 111 may be displaced to the covering part 12 side or to the opposite side of the covering part 12 side.

In addition, in the example described above, the edge part of the opening part 221a includes the guide surface 221b inclined with respect to the axial direction X; however, the guide surface 221b is not always necessary.

In the manufacturing method for the terminal-equipped electric wire 1, the annular covering piece 13 may be removed after the inserting step S4, and the crimping step S5 may be carried out with the annular covering piece 13 removed. In this case, the manufactured terminal-equipped electric wire 1 does not include the annular covering piece 13.

### Reference Example

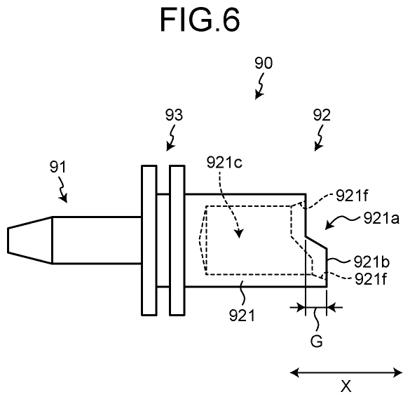

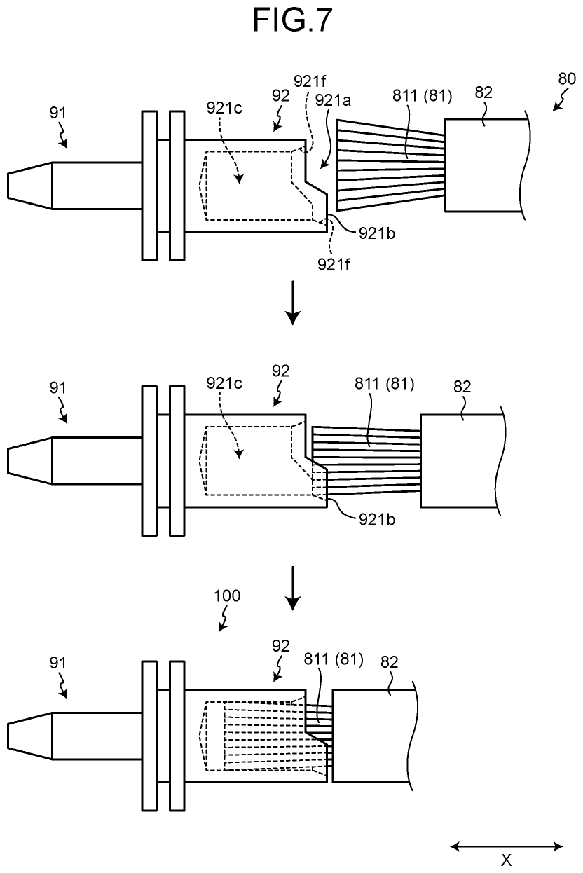

Next, a terminal-equipped electric wire 100 and a manufacturing method for the terminal-equipped electric wire 100 according to a reference example will be described. The terminal-equipped electric wire 100 includes an electric wire 80 and a terminal 90 as illustrated in FIG. 6 and FIG. 7. The electric wire 80 includes a core wire 81 and a covering part 82.

The core wire 81 includes a bundle of a plurality of conductive metal strands formed by a metal material such as copper. The core wire 81 includes a core wire exposed part 811 that is exposed from an end part of the covering part 82. The core wire exposed part 811 is formed by cutting and removing an end part of the covering part 82 in the axial direction X so as to expose a part of the core wire 81. The core wire exposed part 811 is crimped in a state of being accommodated in a core wire accommodating part 92 of the terminal 90, which will be described below.

The covering part 82 has an insulating property and covers the core wire 81. The covering part 82 covers a part of the core wire 81 that excludes the core wire exposed part 811.

The terminal 90 is a terminal formed by a metal member such as copper, a copper alloy, aluminum, or an aluminum alloy and is, for example, a closed barrel crimp terminal. The terminal 90 is a male terminal and is electrically connected to a female terminal (not illustrated) as a counterpart connection member. The terminal 90 includes an electric connection part 91, the core wire accommodating part 92, and a coupling part 93.

The electric connection part 91 is a portion that is formed by extending along the axial direction X and inserted into the female terminal. The electric connection part 91 is electrically connected to the female terminal while being inserted into the female terminal.

The core wire accommodating part 92 is a portion that accommodates the core wire exposed part 811. The core wire accommodating part 92 is a hollow tubular portion formed integrally with the electric connection part 91, and is provided on the opposite side of the electric connection part 91 along the axial direction X via the coupling part 93. The core wire accommodating part 92 includes a tubular body 921 formed in a cylindrical shape.

The tubular part 921 is a portion into which the core wire exposed part 811 is inserted, and includes an interior space part 921c, an opening part 921a, and an extension part 921b.

The interior space part 921c is a space provided inside the tubular body 921 to accommodate the core wire exposed part 811 of the electric wire 80.

The opening part 921a is a portion provided at an end part of the tubular body 921 on the opposite side of the coupling part 93, and opened so that the core wire exposed part 811 can be inserted. The opening part 921a includes a guide surface 921f.

The guide surface 921f guides the tip of the core wire exposed part 811 into the tubular body 921 when the core wire exposed part 811 is inserted into the tubular body 921. The guide surface 921f is an inclined surface that is provided at an edge part of the opening part 921a and formed at an angle to the axial direction X. The guide surface 921f is formed so that the diameter gradually expands from the inside to the outside of the tubular body 921. The guide surface 921f guides the tip of the core wire exposed part 811 so that the tip gathers to the inside of the tubular body 921.

The extension part 921b is a portion partially extending from an edge part of the opening part 921a along the axial direction X. The extension part 921b, for example, partially extends along the axial direction X from the edge part of the opening part 921a by a length G, as illustrated in FIG. 6. The extension part 921b is formed in a rectangular (trapezoidal) shape when viewed from a side direction that intersects (is orthogonal to) the axial direction X. Regarding the extension part 921b, when the tip of the core wire exposed part 811 is inserted into the tubular body 921, the tip of the core wire exposed part 811 is pressed against an inner side of the extension part 921b; thus, the tip of the core wire exposed part 811 that has spread when peeled can be gathered on the extension part 921b side.

The coupling part 93 is a portion that couples the electric connection part 91 and the core wire accommodating part 92. The coupling part 93 exists between the electric connection part 91 and the core wire accommodating part 92 in the axial direction X.

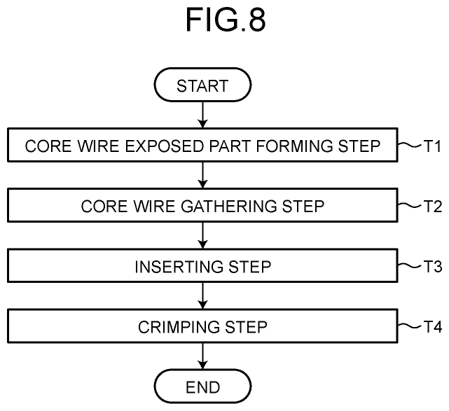

Next, with reference to FIG. 7 and FIG. 8, a manufacturing method for the terminal-equipped electric wire 100 will be described. An operator performs a core wire exposed part forming step T1, in which the core wire exposed part 811 is formed. At the core wire exposed part forming step T1, the operator prepares, for example, the electric wire 80 in which the core wire 81 is entirely covered with the covering part 82. The operator then cuts and removes an end part of the covering part 82 of the electric wire 80 so as to form the core wire exposed part 811 where a part of the core wire 81 is exposed. After the core wire exposed part forming step T1, the operator performs a core wire gathering step T2, in which the tip of the core wire exposed part 811 is gathered to the extension part 921b side. At the core wire gathering step T2, for example, when inserting the tip of the core wire exposed part 811 into the tubular body 921, the operator presses the tip of the core wire exposed part 811 against the extension part 921b, so that the tip of the core wire exposed part 811 that has spread when peeled is gathered on the extension part 921b side. After the core wire gathering step T2, the operator performs an inserting step T3, in which the core wire exposed part 811 is inserted into the core wire accommodating part 92. At the inserting step T3, for example, as illustrated in FIG. 7, the operator inserts the core wire exposed part 811 into the core wire accommodating part 92 while guiding the tip of the core wire exposed part 811 into the core wire accommodating part 92 by the guide surface 921f of the opening part 921a. After the inserting step T3, the operator performs a crimping step T4 to crimp the core wire exposed part 811. At the crimping step T4, for example, while the core wire exposed part 811 is inserted into the core wire accommodating part 92, the operator caulks the core wire accommodating part 92 to deform the core wire accommodating part 92, thereby crimping the core wire exposed part 811. In this way, the operator manufactures the terminal-equipped electric wire 100, in which the electric wire 80 is connected to the terminal 90.

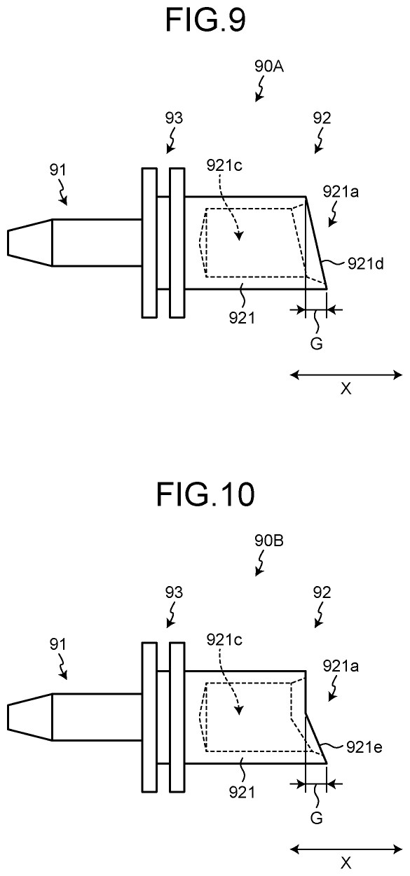

In the above reference example, the extension part 921b is formed in a rectangular (trapezoidal) shape when viewed from the side direction that intersects the axial direction X. However, the present invention is not limited to this example. In another example, an extension part 921d of a terminal 90A may be formed in a triangular shape with the height about equal to that of the tubular body 921 when viewed from the side direction that intersects the axial direction X as illustrated in FIG. 9. In still another example, an extension part 921e of the terminal 90B may be formed in a triangular shape with the height about a half of that of the tubular body 921 when viewed from the side direction that intersects the axial direction X as illustrated in FIG. 10.

In the manufacturing method for a terminal-equipped electric wire according to the present embodiment, the exposed core wire is inserted into the core wire accommodating part with the annular covering piece butted against the opening part of the core wire accommodating part; therefore, for example, the core wire can be inserted into the core wire accommodating part without the use of a jig to receive the annular cover piece, and accordingly, the terminal-equipped electric wire can be manufactured suitably. The terminal-equipped electric wire that enables the insertion into the opening part of the core wire accommodating part with the metal strands at the tip of the core wire exposed part gathered by the annular covering piece can be achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A manufacturing method for a terminal-equipped electric wire, the method comprising:
forming a core wire exposed part by cutting and removing an end part of a covering part of an electric wire including a core wire with conductivity and the covering part that covers the core wire, thereby forming a core wire exposed part where a part of the core wire is exposed;
forming an annular covering piece, after the forming the core wire exposed part, by cutting a part of the covering part on a side of the core wire exposed part into an annular shape, thereby forming the annular covering piece;
moving the annular covering piece from a side of the covering part of the core wire exposed part to a side of a tip of the core wire exposed part;
inserting the core wire exposed part into a core wire accommodating part while sliding the annular covering piece on the core wire exposed part, with the annular covering piece moved to the side of the tip of the core wire exposed part at the moving the annular covering piece butted against an opening part of the core wire accommodating part of a terminal including the core wire accommodating part that accommodates the core wire exposed part and connected to the electric wire; and
crimping the core wire exposed part with the core wire exposed part inserted in the core wire accommodating part.

2. The manufacturing method for a terminal-equipped electric wire according to claim 1, wherein
the opening part includes a guide surface that guides the core wire exposed part and is formed so that an inner diameter of the opening part is smaller than an outer diameter of the annular covering piece, and
at the inserting step, the core wire exposed part is inserted into the core wire accommodating part while the tip of the core wire exposed part is guided into the core wire accommodating part by the guide surface with the annular covering piece butted against the opening part.

3. A terminal-equipped electric wire comprising:
an electric wire including a core wire with conductivity and a covering part that covers the core wire; and
a terminal including an electric connection part to be connected to a counterpart connection member, and a core wire accommodating part with a hollow tubular shape formed integrally with the electric connection part, wherein
the electric wire includes a core wire exposed part exposed from an end part of the covering part and crimped in a state of being accommodated in the core wire accommodating part, and
an annular covering piece provided between the core wire accommodating part and the covering part and formed in an annular shape.

4. The terminal-equipped electric wire according to claim 3, wherein
the core wire accommodating part includes an opening part whose inner diameter is smaller than an outer diameter of the annular covering piece, and
the opening part includes a guide surface that guides a tip of the core wire exposed part into the core wire accommodating part.
